(19) United States
(12) Patent Application Publication
(10) Pub. No.: US 2024/0214285 A1
(43) Pub. Date: Jun. 27, 2024

(54) APPLICATION MONITORING PRIORITIZATION

(71) Applicant: CISCO TECHNOLOGY, INC., Cupertino, CA (US)

(72) Inventors: Jackson Ngoc Ki Pang, Sunnyvale, CA (US); Navindra Yadav, Cupertino, CA (US); Anubhav Gupta, Fremont, CA (US); Shashidhar Gandham, Fremont, CA (US); Supreeth Hosur Nagesh Rao, Cupertino, CA (US); Sunil Kumar Gupta, Milpitas, CA (US)

(21) Appl. No.: 18/435,803

(22) Filed: Feb. 7, 2024

Related U.S. Application Data
(63) Continuation of application No. 17/935,771, filed on Sep. 27, 2022, now Pat. No. 11,902,122.
Application No. 17/935,771 is a continuation of application No. 16/867,791, filed on May 6, 2020, now Pat. No. 11,522,775.
Application No. 16/867,791 is a continuation of application No. 15/173,477, filed on Jun. 3, 2016, now Pat. No. 10,659,324.
(60) Provisional application No. 62/171,899, filed on Jun. 5, 2015.

(51) Int. Cl. H04L 43/045; G06F 3/0482; G06F 3/04842; G06F 3/04847; G06F 9/455; G06F 16/11; G06F 16/13; G06F 16/16; G06F 16/17; G06F 16/174; G06F 16/23; G06F 16/2457; G06F 16/248; G06F 16/28; G06F 16/29; G06F 16/9535; G06F 21/53; G06F 21/55; G06F 21/56; G06N 20/00; G06N 99/00; G06T 11/20; H04J 3/06; H04J 3/14; H04L 1/24; H04L 7/10; H04L 9/08; H04L 9/32; H04L 9/40; H04L 41/046; H04L 41/0668; H04L 41/0803; H04L 41/0806; H04L 41/0816; H04L 41/0893; H04L 41/12; H04L 41/16; H04L 41/22; H04L 43/02; H04L 43/026; H04L 43/04; H04L 43/062; H04L 43/08; H04L 43/0805; H04L 43/0811; H04L 43/0829; H04L 43/0852; H04L 43/0864; H04L 43/0876; H04L 43/0882; H04L 43/0888; H04L 43/10; H04L 43/106; H04L 43/12; H04L 43/16; H04L 45/00; H04L 45/302; H04L 45/50; H04L 45/74; H04L 47/11; H04L 47/20; H04L 47/2441; H04L 47/2483; H04L 47/28; H04L 47/31; H04L 47/32; H04L 61/5007; H04L 67/01; H04L 67/10; H04L 67/1001; H04L 67/12; H04L 67/50; H04L 67/51; H04L 67/75; H04L 69/16; H04L 69/22; H04W 72/54; H04W 84/18

(52) U.S. Cl. CPC H04L 43/045; G06F 3/0482; G06F 3/04842; G06F 3/04847; G06F 9/45558; G06F 16/122; G06F 16/137; G06F 16/162; G06F 16/17; G06F 16/173; G06F 16/174; G06F 16/1744; G06F 16/1748; G06F 16/2322; G06F 16/235; G06F 16/2365; G06F 16/24578; G06F 16/248; G06F 16/285; G06F 16/288; G06F 16/29; G06F 16/9535; G06F 21/53; G06F 21/552; G06F 21/556; G06F 21/566; G06N 20/00; G06N 99/00; G06T 11/206; H04J 3/0661; H04J 3/14; H04L 1/242; H04L 7/10; H04L 9/0866; H04L 9/3239; H04L 9/3242; H04L 41/046; H04L 41/0668; H04L 41/0803; H04L 41/0806; H04L 41/0816; H04L 41/0893; H04L 41/12; H04L 41/16; H04L 41/22; H04L 43/02; H04L 43/026; H04L 43/04; H04L 43/062; H04L 43/08; H04L 43/0805; H04L 43/0811; H04L 43/0829; H04L 43/0841; H04L 43/0858; H04L 43/0864; H04L 43/0876; H04L 43/0882; H04L 43/0888; H04L 43/10; H04L 43/106; H04L 43/12; H04L 43/16; H04L 45/306; H04L 45/38; H04L 45/46; H04L 45/507; H04L 45/66; H04L 45/74; H04L 47/11; H04L 47/20; H04L 47/2441; H04L 47/2483; H04L 47/28; H04L 47/31; H04L 47/32; H04L 61/5007; H04L 63/0227; H04L 63/0263; H04L 63/06; H04L 63/0876; H04L 63/1408; H04L 63/1416; H04L 63/1425; H04L 63/1433; H04L 63/1441; H04L 63/145; H04L 63/1458; H04L 63/1466; H04L 63/16; H04L 63/20; H04L 67/01; H04L 67/10; H04L 67/1001; H04L 67/12; H04L 67/51; H04L 67/75; H04L 69/16; H04L 69/22; H04W 72/54; H04W 84/18; G06F 2009/4557; G06F 2009/45587; G06F 2009/45591; G06F 2009/45595; G06F 2221/033; G06F 2221/2101; G06F 2221/2105; G06F 2221/2111; G06F 2221/2115; G06F 2221/2145; H04L 67/535

(57) ABSTRACT

An approach for establishing a priority ranking for endpoints in a network. This can be useful when triaging endpoints after an endpoint becomes compromised. Ensuring that the most critical and vulnerable endpoints are triaged first can help maintain network stability and mitigate damage to endpoints in the network after an endpoint is compromised. The present technology involves determining a criticality ranking and a secondary value for a first endpoint in a datacenter. The criticality ranking and secondary value can be combined to form priority ranking for the first endpoint which can then be compared to a priority ranking for a second endpoint to determine if the first endpoint or the second endpoint should be triaged first.

### RELATED APPLICATIONS

This application is a continuation of U.S. patent application Ser. No. 17/935,771, filed on Sep. 27, 2022, which in turn, is a continuation of U.S. patent application Ser. No. 16/867,791, filed on May. 6, 2020, which in turn, is a continuation of U.S. patent application Ser. No. 15/173,477 filed on Jun. 3, 2016, which claims the benefit of U.S. Provisional Patent Application Ser. No. 62/171,899 filed on Jun. 5, 2015, the contents of which are incorporated by reference in their entireties.

### TECHNICAL FIELD

The present technology pertains to network security and more specifically establishing a priority ranking for an endpoint.

### BACKGROUND

When an endpoint is compromised in a network, other endpoints may become compromised as well. It can be important to triage the other nodes and determine if they are also compromised or if they are at risk of being compromised in the future. In a datacenter, there can be a large number of endpoints and triaging each one can take a large amount of time. An endpoint at the tail end of the triage queue might become compromised while awaiting triage.

### BRIEF DESCRIPTION OF THE FIGURES

In order to describe the manner in which the above-recited and other advantages and features of the disclosure can be obtained, a more particular description of the principles briefly described above will be rendered by reference to specific embodiments that are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 illustrates an example network traffic monitoring system according to some example embodiments;

FIG. 2 illustrates an example network environment according to some example embodiments;

FIG. 3A, FIG. 3B, FIG. 3C, and FIG. 3D illustrate example network configurations;

FIG. 4 illustrates an example table depicting example business criticality rankings, secondary values, and priority rankings of various example applications;

FIG. 5 illustrates an example method according to some embodiments;

FIG. 6 illustrates and example method according to some embodiments; and

FIGS. 7A and 7B illustrate example system embodiments.

### DESCRIPTION OF EXAMPLE EMBODIMENTS

### Overview

An approach for establishing a priority ranking for endpoints in a network. This can be useful when triaging endpoints after an endpoint becomes compromised. Ensuring that the most critical and vulnerable endpoints are triaged first can help maintain network stability and mitigate damage to endpoints in the network after an endpoint is compromised. The present technology involves determining a criticality ranking and a secondary value for a first endpoint in a datacenter. The criticality ranking and secondary value can be combined to form priority ranking for the first endpoint which can then be compared to a priority ranking for a second endpoint to determine if the first endpoint or the second endpoint should be triaged first.

### Detailed Description

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for determining a priority ranking for endpoints in a network.

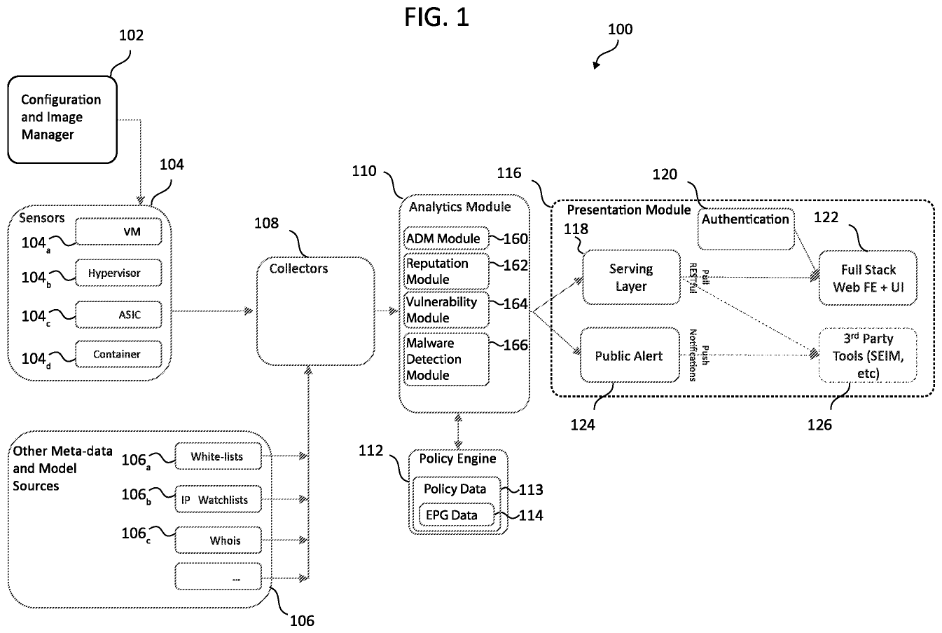

FIG. 1 shows an example network traffic monitoring system 100 according to some example embodiments. Network traffic monitoring system 100 can include configuration and image manager 102, sensors 104, external data sources 106, collectors 108, analytics module 110, policy engine 112, and presentation module 116. These modules may be implemented as hardware and/or software components. Although FIG. 1 illustrates an example configuration of the various components of network traffic monitoring system 100, those of skill in the art will understand that the components of network traffic monitoring system 100 or any system described herein can be configured in a number of different ways and can include any other type and number of components. For example, sensors 104 and collectors 108 can belong to one hardware and/or software module or multiple separate modules. Other modules can also be combined into fewer components and/or further divided into more components.

Configuration and image manager 102 can provision and maintain sensors 104. In some example embodiments, sensors 104 can reside within virtual machine images, and configuration and image manager 102 can be the component that also provisions virtual machine images.

Configuration and image manager 102 can configure and manage sensors 104. When a new virtual machine (VM) is instantiated or when an existing VM is migrated, configuration and image manager 102 can provision and configure a new sensor on the physical server hosting the VM. In some example embodiments configuration and image manager 102 can monitor the health of sensors 104. For instance, configuration and image manager 102 may request status updates or initiate tests. In some example embodiments, configuration and image manager 102 can also manage and provision the virtual machines themselves.

In some example embodiments, configuration and image manager 102 can verify and validate sensors 104. For example, sensors 104 can be provisioned a unique ID that is created using a one-way hash function of its basic input/output system (BIOS) universally unique identifier (UUID) and a secret key stored on configuration and image manager 102. This UUID can be a large number that is difficult for an imposter sensor to guess. In some example embodiments, configuration and image manager 102 can keep sensors 104 up to date by installing new versions of their software and applying patches. Configuration and image manager 102 can obtain these updates automatically from a local source or the Internet.

Sensors 104 can reside on nodes of a data center network (e.g., virtual partition, hypervisor, physical server, switch, router, gateway, other network device, other electronic device, etc.). In general, a virtual partition may be an instance of a virtual machine (VM) (e.g., VM 104a), sandbox, container (e.g., container 104c), or any other isolated environment that can have software operating within it. The software may include an operating system and application software. For software running within a virtual partition, the virtual partition may appear to be a distinct physical server. In some example embodiments, a hypervisor (e.g., hypervisor 104b) may be a native or “bare metal” hypervisor that runs directly on hardware, but that may alternatively run under host software executing on hardware. Sensors 104 can monitor communications to and from the nodes and report on environmental data related to the nodes (e.g., node IDs, statuses, etc.). Sensors 104 can send their records over a high-speed connection to collectors 108 for storage. Sensors 104 can comprise a piece of software (e.g., running on a VM, container, virtual switch, hypervisor, physical server, or other device), an application-specific integrated circuit (ASIC) (e.g., a component of a switch, gateway, router, standalone packet monitor, or other network device including a packet capture (PCAP) module or similar technology), or an independent unit (e.g., a device connected to a network device's monitoring port or a device connected in series along a main trunk of a datacenter). It should be understood that various software and hardware configurations can be used as sensors 104. Sensors 104 can be lightweight, thereby minimally impeding normal traffic and compute resources in a datacenter. Sensors 104 can “sniff” packets being sent over its host network interface card (NIC) or individual processes can be configured to report traffic to sensors 104. This sensor structure allows for robust capture of granular (i.e., specific) network traffic data from each hop of data transmission.

As sensors 104 capture communications, they can continuously send network traffic and associated data to collectors 108. The network traffic data can relate to a packet, a collection of packets, a flow, a group of flows, etc. The associated data can include details such as the VM BIOS ID, sensor ID, associated process ID, associated process name, process user name, sensor private key, geo-location of a sensor, environmental details, etc. The network traffic data can include information describing the communication on all layers of the Open Systems Interconnection (OSI) model. For example, the network traffic data can include signal strength (if applicable), source/destination media access control (MAC) address, source/destination internet protocol (IP) address, protocol, port number, encryption data, requesting process, a sample packet, etc.

In some example embodiments, sensors 104 can preprocess network traffic data before sending to collectors 108. For example, sensors 104 can remove extraneous or duplicative data or they can create a summary of the data (e.g., latency, packets and bytes sent per flow, flagged abnormal activity, etc.). In some example embodiments, sensors 104 can be configured to only capture certain types of connection information and disregard the rest. Because it can be overwhelming for a system to capture every packet in a network, in some example embodiments, sensors 104 can be configured to capture only a representative sample of packets (e.g., every 1,000th packet or other suitable sample rate).

Sensors 104 can send network traffic data to one or multiple collectors 108. In some example embodiments, sensors 104 can be assigned to a primary collector and a secondary collector. In other example embodiments, sensors 104 are not assigned a collector, but can determine an optimal collector through a discovery process. Sensors 104 can change where they send their network traffic data if their environments change, such as if a certain collector experiences failure or if a sensor is migrated to a new location and becomes closer to a different collector. In some example embodiments, sensors 104 can send different types of network traffic data to different collectors. For example, sensors 104 can send network traffic data related to one type of process to one collector and network traffic data related to another type of process to another collector.

Collectors 108 can serve as a repository for the data recorded by sensors 104. In some example embodiments, collectors 108 can be directly connected to a top of rack switch. In other example embodiments, collectors 108 can be located near an end of row switch. Collectors 108 can be located on or off premises. It will be appreciated that the placement of collectors 108 can be optimized according to various priorities such as network capacity, cost, and system responsiveness. In some example embodiments, data storage of collectors 108 is located in an in-memory database, such as dashDB by International Business Machines. This approach benefits from rapid random access speeds that typically are required for analytics software. Alternatively, collectors 108 can utilize solid state drives, disk drives, magnetic tape drives, or a combination of the foregoing according to cost, responsiveness, and size requirements. Collectors 108 can utilize various database structures such as a normalized relational database or NoSQL database.

In some example embodiments, collectors 108 may only serve as network storage for network traffic monitoring system 100. In other example embodiments, collectors 108 can organize, summarize, and preprocess data. For example, collectors 108 can tabulate how often packets of certain sizes or types are transmitted from different nodes of a data center. Collectors 108 can also characterize the traffic flows going to and from various nodes. In some example embodiments, collectors 108 can match packets based on sequence numbers, thus identifying traffic flows and connection links. In some example embodiments, collectors 108 can flag anomalous data. Because it would be inefficient to retain all data indefinitely, in some example embodiments, collectors 108 can periodically replace detailed network traffic flow data and associated data (host data, process data, user data, etc.) with consolidated summaries. In this manner, collectors 108 can retain a complete dataset describing one period (e.g., the past minute or other suitable period of time), with a smaller dataset of another period (e.g., the previous 2-10 minutes or other suitable period of time), and progressively consolidate network traffic flow data and associated data of other periods of time (e.g., day, week, month, year, etc.). By organizing, summarizing, and preprocessing the network traffic flow data and associated data, collectors 108 can help network traffic monitoring system 100 scale efficiently. Although collectors 108 are generally referred to herein in the plurality, it will be appreciated that collectors 108 can be implemented using a single machine, especially for smaller datacenters.

In some example embodiments, collectors 108 can receive data from external data sources 106, such as security reports, white-lists (106a), IP watchlists (106b), whois data (106c), or out-of-band data, such as power status, temperature readings, etc.

In some example embodiments, network traffic monitoring system 100 can include a wide bandwidth connection between collectors 108 and analytics module 110. Analytics module 110 can include application dependency (ADM) module 160, reputation module 162, vulnerability module 164, malware detection module 166, etc., to accomplish various tasks with respect to the flow data and associated data collected by sensors 104 and stored in collectors 108. In some example embodiments, network traffic monitoring system 100 can automatically determine network topology. Using network traffic flow data and associated data captured by sensors 104, network traffic monitoring system 100 can determine the type of devices existing in the network (e.g., brand and model of switches, gateways, machines, etc.), physical locations (e.g., latitude and longitude, building, datacenter, room, row, rack, machine, etc.), interconnection type (e.g., 10 Gb Ethernet, fiber-optic, etc.), and network characteristics (e.g., bandwidth, latency, etc.). Automatically determining the network topology can assist with integration of network traffic monitoring system 100 within an already established datacenter. Furthermore, analytics module 110 can detect changes of network topology without the need of further configuration.

Analytics module 110 can determine dependencies of components within the network using ADM module 160. For example, if component A routinely sends data to component B but component B never sends data to component A, then analytics module 110 can determine that component B is dependent on component A, but A is likely not dependent on component B. If, however, component B also sends data to component A, then they are likely interdependent. These components can be processes, virtual machines, hypervisors, virtual local area networks (VLANs), etc. Once analytics module 110 has determined component dependencies, it can then form a component (“application”) dependency map. This map can be instructive when analytics module 110 attempts to determine a root cause of a failure (because failure of one component can cascade and cause failure of its dependent components). This map can also assist analytics module 110 when attempting to predict what will happen if a component is taken offline. Additionally, analytics module 110 can associate edges of an application dependency map with expected latency, bandwidth, etc. for that individual edge.

Analytics module 110 can establish patterns and norms for component behavior. For example, it can determine that certain processes (when functioning normally) will only send a certain amount of traffic to a certain VM using a small set of ports. Analytics module can establish these norms by analyzing individual components or by analyzing data coming from similar components (e.g., VMs with similar configurations). Similarly, analytics module 110 can determine expectations for network operations. For example, it can determine the expected latency between two components, the expected throughput of a component, response times of a component, typical packet sizes, traffic flow signatures, etc. In some example embodiments, analytics module 110 can combine its dependency map with pattern analysis to create reaction expectations. For example, if traffic increases with one component, other components may predictably increase traffic in response (or latency, compute time, etc.).

In some example embodiments, analytics module 110 can use machine learning techniques to identify security threats to a network using malware detection module 166. For example, malware detection module 166 can be provided with examples of network states corresponding to an attack and network states corresponding to normal operation. Malware detection module 166 can then analyze network traffic flow data and associated data to recognize when the network is under attack. In some example embodiments, the network can operate within a trusted environment for a time so that analytics module 110 can establish baseline normalcy. In some example embodiments, analytics module 110 can contain a database of norms and expectations for various components. This database can incorporate data from sources external to the network (e.g., external sources 106). Analytics module 110 can then create access policies for how components can interact using policy engine 112. In some example embodiments, policies can be established external to network traffic monitoring system 100 and policy engine 112 can detect the policies and incorporate them into analytics module 110. A network administrator can manually tweak the policies. Policies can dynamically change and be conditional on events. These policies can be enforced by the components depending on a network control scheme implemented by a network. Policy engine 112 can maintain these policies and receive user input to change the policies.

Policy engine 112 can configure analytics module 110 to establish or maintain network policies. For example, policy engine 112 may specify that certain machines should not intercommunicate or that certain ports are restricted. A network and security policy controller (not shown) can set the parameters of policy engine 112. In some example embodiments, policy engine 112 can be accessible via presentation module 116. In some example embodiments, policy engine 112 can include policy data 112. In some example embodiments, policy data 112 can include endpoint group (EPG) data 114, which can include the mapping of EPGs to IP addresses and/or MAC addresses. In some example embodiments, policy data 112 can include policies for handling data packets.

In some example embodiments, analytics module 110 can simulate changes in the network. For example, analytics module 110 can simulate what may result if a machine is taken offline, if a connection is severed, or if a new policy is implemented. This type of simulation can provide a network administrator with greater information on what policies to implement. In some example embodiments, the simulation may serve as a feedback loop for policies. For example, there can be a policy that if certain policies would affect certain services (as predicted by the simulation) those policies should not be implemented. Analytics module 110 can use simulations to discover vulnerabilities in the datacenter. In some example embodiments, analytics module 110 can determine which services and components will be affected by a change in policy. Analytics module 110 can then take necessary actions to prepare those services and components for the change. For example, it can send a notification to administrators of those services and components, it can initiate a migration of the components, it can shut the components down, etc.

In some example embodiments, analytics module 110 can supplement its analysis by initiating synthetic traffic flows and synthetic attacks on the datacenter. These artificial actions can assist analytics module 110 in gathering data to enhance its model. In some example embodiments, these synthetic flows and synthetic attacks are used to verify the integrity of sensors 104, collectors 108, and analytics module 110. Over time, components may occasionally exhibit anomalous behavior. Analytics module 110 can analyze the frequency and severity of the anomalous behavior to determine a reputation score for the component using reputation module 162. Analytics module 110 can use the reputation score of a component to selectively enforce policies. For example, if a component has a high reputation score, the component may be assigned a more permissive policy or more permissive policies; while if the component frequently violates (or attempts to violate) its relevant policy or policies, its reputation score may be lowered and the component may be subject to a stricter policy or stricter policies. Reputation module 162 can correlate observed reputation score with characteristics of a component. For example, a particular virtual machine with a particular configuration may be more prone to misconfiguration and receive a lower reputation score. When a new component is placed in the network, analytics module 110 can assign a starting reputation score similar to the scores of similarly configured components. The expected reputation score for a given component configuration can be sourced outside of the datacenter. A network administrator can be presented with expected reputation scores for various components before installation, thus assisting the network administrator in choosing components and configurations that will result in high reputation scores.

Some anomalous behavior can be indicative of a misconfigured component or a malicious attack. Certain attacks may be easy to detect if they originate outside of the datacenter, but can prove difficult to detect and isolate if they originate from within the datacenter. One such attack could be a distributed denial of service (DDOS) where a component or group of components attempt to overwhelm another component with spurious transmissions and requests. Detecting an attack or other anomalous network traffic can be accomplished by comparing the expected network conditions with actual network conditions. For example, if a traffic flow varies from its historical signature (packet size, transport control protocol header options, etc.) it may be an attack.

In some cases, a traffic flow and associated data may be expected to be reported by a sensor, but the sensor may fail to report it. This situation could be an indication that the sensor has failed or become compromised. By comparing the network traffic flow data and associated data from multiple sensors 104 spread throughout the datacenter, analytics module 110 can determine if a certain sensor is failing to report a particular traffic flow.

Presentation module 116 can include serving layer 118, authentication module 120, web front end 122, public alert module 124, and third party tools 126. In some example embodiments, presentation module 116 can provide an external interface for network monitoring system 100. Using presentation module 116, a network administrator, external software, etc. can receive data pertaining to network monitoring system 100 via a webpage, application programming interface (API), audiovisual queues, etc. In some example embodiments, presentation module 116 can preprocess and/or summarize data for external presentation. In some example embodiments, presentation module 116 can generate a webpage. As analytics module 110 processes network traffic flow data and associated data and generates analytic data, the analytic data may not be in a human-readable form or it may be too large for an administrator to navigate. Presentation module 116 can take the analytic data generated by analytics module 110 and further summarize, filter, and organize the analytic data as well as create intuitive presentations of the analytic data.

Serving layer 118 can be the interface between presentation module 116 and analytics module 110. As analytics module 110 generates reports, predictions, and conclusions, serving layer 118 can summarize, filter, and organize the information that comes from analytics module 110. In some example embodiments, serving layer 118 can also request raw data from a sensor or collector.

Web frontend 122 can connect with serving layer 118 to present the data from serving layer 118 in a webpage. For example, web frontend 122 can present the data in bar charts, core charts, tree maps, acyclic dependency maps, line graphs, tables, etc. Web frontend 122 can be configured to allow a user to “drill down” on information sets to get a filtered data representation specific to the item the user wishes to drill down to. For example, individual traffic flows, components, etc. Web frontend 122 can also be configured to allow a user to filter by search. This search filter can use natural language processing to analyze the user's input. There can be options to view data relative to the current second, minute, hour, day, etc. Web frontend 122 can allow a network administrator to view traffic flows, application dependency maps, network topology, etc.

In some example embodiments, web frontend 122 may be solely configured to present information. In other example embodiments, web frontend 122 can receive inputs from a network administrator to configure network traffic monitoring system 100 or components of the datacenter. These instructions can be passed through serving layer 118 to be sent to configuration and image manager 102 or policy engine 112. Authentication module 120 can verify the identity and privileges of users. In some example embodiments, authentication module 120 can grant network administrators different rights from other users according to established policies.

Public alert module 124 can identify network conditions that satisfy specified criteria and push alerts to third party tools 126. Public alert module 124 can use analytic data generated or accessible through analytics module 110. One example of third party tools 126 is a security information and event management system (SIEM). Third party tools 126 may retrieve information from serving layer 118 through an API and present the information according to the SIEM's user interfaces.

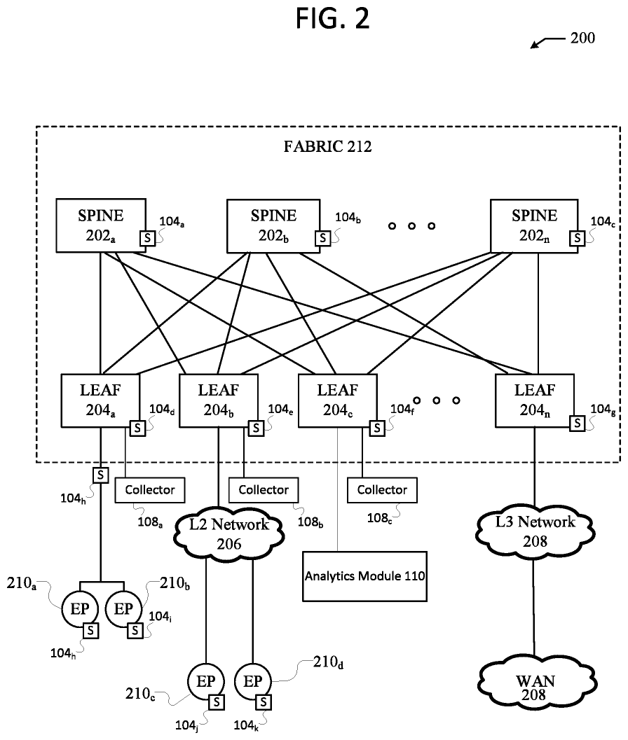

FIG. 2 illustrates an example network environment 200 according to some example embodiments. It should be understood that, for the network environment 100 and any environment discussed herein, there can be additional or fewer nodes, devices, links, networks, or components in similar or alternative configurations. Example embodiments with different numbers and/or types of clients, networks, nodes, cloud components, servers, software components, devices, virtual or physical resources, configurations, topologies, services, appliances, deployments, or network devices are also contemplated herein. Further, network environment 200 can include any number or type of resources, which can be accessed and utilized by clients or tenants. The illustrations and examples provided herein are for clarity and simplicity.

Network environment 200 can include network fabric 212, layer 2 (L2) network 206, layer 3 (L3) network 208, endpoints 210a, 210b, . . . , and 210d (collectively, “204”). Network fabric 212 can include spine switches 202a, 202b, . . . , 202n (collectively, “202”) connected to leaf switches 204a, 204b, 204c, . . . , 204n (collectively, “204”). Spine switches 202 can connect to leaf switches 204 in network fabric 212. Leaf switches 204 can include access ports (or non-fabric ports) and fabric ports. Fabric ports can provide uplinks to spine switches 202, while access ports can provide connectivity for devices, hosts, endpoints, VMs, or other electronic devices (e.g., endpoints 204), internal networks (e.g., L2 network 206), or external networks (e.g., L3 network 208).

Leaf switches 204 can reside at the edge of network fabric 212, and can thus represent the physical network edge. In some cases, leaf switches 204 can be top-of-rack switches configured according to a top-of-rack architecture. In other cases, leaf switches 204 can be aggregation switches in any particular topology, such as end-of-row or middle-of-row topologies. Leaf switches 204 can also represent aggregation switches, for example.

Network connectivity in network fabric 212 can flow through leaf switches 204. Here, leaf switches 204 can provide servers, resources, VMs, or other electronic devices (e.g., endpoints 210), internal networks (e.g., L2 network 206), or external networks (e.g., L3 network 208), access to network fabric 212, and can connect leaf switches 204 to each other. In some example embodiments, leaf switches 204 can connect endpoint groups (EPGs) to network fabric 212, internal networks (e.g., L2 network 206), and/or any external networks (e.g., L3 network 208). EPGs can be used in network environment 200 for mapping applications to the network. In particular, EPGs can use a grouping of application endpoints in the network to apply connectivity and policy to the group of applications. EPGs can act as a container for buckets or collections of applications, or application components, and tiers for implementing forwarding and policy logic. EPGs also allow separation of network policy, security, and forwarding from addressing by instead using logical application boundaries. For example, each EPG can connect to network fabric 212 via leaf switches 204.

Endpoints 210 can connect to network fabric 212 via leaf switches 204. For example, endpoints 210a and 210b can connect directly to leaf switch 204a, which can connect endpoints 210a and 210b to network fabric 212 and/or any other one of leaf switches 204. Endpoints 210c and 210d can connect to leaf switch 204b via L2 network 206. Endpoints 210c and 210d and L2 network 206 are examples of LANs. LANs can connect nodes over dedicated private communications links located in the same general physical location, such as a building or campus.

Wide area network (WAN) 212 can connect to leaf switches 204c or 204d via L3 network 208. WANs can connect geographically dispersed nodes over long-distance communications links, such as common carrier telephone lines, optical lightpaths, synchronous optical networks (SONET), or synchronous digital hierarchy (SDH) links. LANs and WANs can include layer 2 (L2) and/or layer 3 (L3) networks and endpoints.

The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other.

Computer networks may be further interconnected by an intermediate network node, such as a router, to extend the effective size of each network. Endpoints 210 can include any communication device or component, such as a computer, server, hypervisor, virtual machine, container, process (e.g., running on a virtual machine), switch, router, gateway, host, device, external network, etc. In some example embodiments, endpoints 210 can include a server, hypervisor, process, or switch configured with virtual tunnel endpoint (VTEP) functionality which connects an overlay network with network fabric 212. The overlay network may allow virtual networks to be created and layered over a physical network infrastructure. Overlay network protocols, such as Virtual Extensible LAN (VXLAN), Network Virtualization using Generic Routing Encapsulation (NVGRE), Network Virtualization Overlays (NVO3), and Stateless Transport Tunneling (STT), can provide a traffic encapsulation scheme which allows network traffic to be carried across L2 and L3 networks over a logical tunnel. Such logical tunnels can be originated and terminated through VTEPs. The overlay network can host physical devices, such as servers, applications, endpoint groups, virtual segments, virtual workloads, etc. In addition, endpoints 210 can host virtual workload(s), clusters, and applications or services, which can connect with network fabric 212 or any other device or network, including an internal or external network. For example, endpoints 210 can host, or connect to, a cluster of load balancers or an EPG of various applications.

Network environment 200 can also integrate a network traffic monitoring system, such as the one shown in FIG. 1. For example, as shown in FIG. 2, the network traffic monitoring system can include sensors 104a, 104b, . . . , 104n (collectively, “104”), collectors 108a, 108b, . . . 108n (collectively, “108”), and analytics module 110. In some example embodiments, spine switches 202 do not have sensors 104. Analytics module 110 can receive and process network traffic and associated data collected by collectors 108 and detected by sensors 104 placed on nodes located throughout network environment 200. In some example embodiments, analytics module 110 can be implemented in an active-standby model to ensure high availability, with a first analytics module functioning in a primary role and a second analytics module functioning in a secondary role. If the first analytics module fails, the second analytics module can take over control. Although analytics module 110 is shown to be a standalone network appliance in FIG. 2, it will be appreciated that analytics module 110 can also be implemented as a VM image that can be distributed onto a VM, a cluster of VMs, a software as a service (SaaS), or other suitable distribution model in various other example embodiments. In some example embodiments, sensors 104 can run on endpoints 210, leaf switches 204, spine switches 202, in-between network elements (e.g., sensor 104h), etc. In some example embodiments, leaf switches 204 can each have an associated collector 108. For example, if leaf switch 204 is a top of rack switch then each rack can contain an assigned collector 108.

Although network fabric 212 is illustrated and described herein as an example leaf-spine architecture, one of ordinary skill in the art will readily recognize that the subject technology can be implemented based on any network topology, including any data center or cloud network fabric. Indeed, other architectures, designs, infrastructures, and variations are contemplated herein. For example, the principles disclosed herein are applicable to topologies including three-tier (including core, aggregation, and access levels), fat tree, mesh, bus, hub and spoke, etc. It should be understood that sensors and collectors can be placed throughout the network as appropriate according to various architectures.

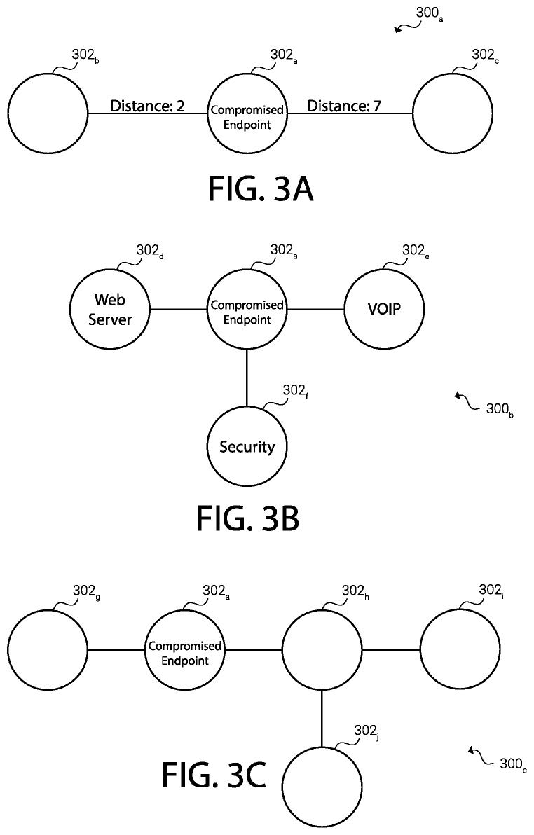

FIG. 3A, FIG. 3B, FIG. 3C, and FIG. 3D represent example network configurations of network environment 200. Various endpoints 302ₐ-302ₘ (collectively or individually, “endpoint 302”) can run services within the network. Endpoint 302 can be similar to endpoint 210. Endpoint 302 can be associated with an application (e.g., mail server, web server, security application, voice over IP, storage host, etc.). Endpoint 302 can be a network switch, router, firewall, etc. Endpoint 302 can comprise a virtual machine, bare metal hardware, container, etc. Endpoint 302 can run on a virtual machine, bare metal hardware, container, etc.

In FIGS. 3A-3D, compromised endpoint 302ₐ can represent an endpoint 302 that has been compromised or misconfigured. For example, a sensor 104 associated with endpoint 302ₐ might have stopped reporting, reported irregular traffic or behavior, or otherwise indicated that endpoint 302ₐ is compromised. Compromised endpoint 302ₐ might be running a virus, worm, other unauthorized programs, misconfigured programs, etc. Network monitoring system 100 can identify compromised endpoint 302 using the principles herein disclosed.

When an endpoint 302 becomes compromised, there is a risk that it was compromised from another endpoint 302 on network 300, that it has or will compromise other endpoints 302, or the entity which compromised it might compromise other endpoints 302. It can be useful to perform triage with other endpoints 302 to determine their risk to the same causes that compromised endpoint 302ₐ as well as implement defensive and remedial procedures. Triage, as used herein can entail ascertaining the present state of the endpoint 302, determining actions to be performed, and performing those actions. For example, network monitoring system 100 can block communications to another endpoint 302 that has a likelihood of becoming compromised, including blocking communications from compromised endpoint 302ₐ to a vulnerable endpoint 302. Because not all endpoints 302 can be triaged at once, a prioritization scheme can be used to queue up analyzing and protecting endpoints 302. For example, endpoints 302 can be assigned a priority ranking and can be analyzed in according to their priority ranking. The priority ranking can be established using a variety of criteria such as distance, critically (e.g., business criticality), network connectivity, redundancy, vulnerability, similarity to compromised endpoint 302ₐ, etc. A combination of criteria can also be utilized. It should be understood that the connections depicted in FIGS. 3A-3D can represent direct connections or indirect connections (e.g., those that require an intermediary).

In FIG. 3A, endpoint 302_{b} is a distance of 2 away from compromised endpoint 302ₐ while endpoint 302_{c} is a distance of 7 away from compromised endpoint 302ₐ. Distance can refer to the latency between two endpoints 302, the bandwidth between two endpoints 302, the number of hops in a path connecting two endpoints 302, the geographical distance between two endpoints 302, the redundancy in the connections between the two endpoints 320, etc. Distance can be calculated using any combination of the foregoing.

Network monitoring system 100 can determine the distances between two endpoints 302. For example, sensor 104 on an endpoint 302 can ping another endpoint 302 and, based on the response, can determine the latency between the two endpoints 302. Other techniques are contemplated for determining distances between endpoints 302. In some embodiments, a lower distance can result in a higher priority ranking for an endpoint 302. An endpoint 302 with a higher priority ranking can be triaged before an endpoint 302 with a lower priority ranking. It should be understood that “higher” and “lower” rankings and values as used herein can mean of greater importance or lesser priority as appropriate.

In FIG. 3B, compromised endpoint 302ₐ is connected to web server endpoint 302_{d}, voice over internet protocol (VOIP) endpoint 302ₑ, and security endpoint 302_{f}. Other endpoints associated with other applications are contemplated that can be run on an endpoint 302. For example, an endpoint can run an application for data storage, telecommunications, closed circuit television, data processing, finance, point-of-sale terminals, tech-support, video on demand, etc. In some embodiments, certain applications are especially critical to the business that owns or uses them. Endpoints 302 that are business critical can be those that would cause serious damage to the particular business should they have any problems. For example, a social network may consider web server endpoint 302_{d} to be critical for the business whereas a telecommunications provider may consider VOIP endpoint 302ₑ to be more critical to their business than web server endpoint 302_{d}.

In some embodiments, business criticality can be provided by an administrator. For example, an administrator can indicate a business criticality ranking for a variety of endpoint classifications. Endpoints can be classified similar to the foregoing (e.g., “telecommunications”, “data storage”, etc.). Additionally or alternatively, business criticality can be determined based on an analysis of network 300 provided by network monitoring system 100. For example, network monitoring system 100 can determine that many communications and interactions depend on a classification of endpoint 302. Similarly, network monitoring system 100 can create an application dependency map which can inform criticality rankings.

An endpoint 302 with a higher business criticality ranking can be prioritized over other endpoints 302. For example, the business criticality ranking can inform a priority ranking.

In FIG. 3C, compromised endpoint 302ₐ is connected directly to endpoint 302_{g} and 302ₕ. Endpoint 302ₕ is connected to endpoint 302ᵢ and endpoint 302ⱼ. If an endpoint 302 serves as a hub for interconnecting multiple endpoints 302 it can have a higher priority ranking. For example, because endpoint 302ₕ is connected to endpoints 302ₐ, 302ᵢ, and 302ⱼ, it can have a higher priority ranking in comparison to endpoint 302_{g} which is only connected to endpoint 302ₐ. The more endpoints 302 that an endpoint 302 is connected to, the greater its priority ranking can be. In some embodiments, the priority ranking of an endpoint 302 is only increased based on the number of directly connected endpoints 302 it has; alternatively, the priority ranking can increase based on the number of indirectly connected endpoints 302. The priority ranking can be higher based on a distance-weighting of the number of connected endpoints 302, the distance being calculated as discussed above. The priority ranking can be higher based on the number of endpoints 302 that an endpoint 302 “protects” from compromised endpoint 302ₐ. Protecting an endpoint can mean that communications from a protected endpoint 302 must go through this endpoint if they are to reach compromised endpoint 302ₐ.

In FIG. 3D, compromised endpoint 402ₐ is connected to Endpoint A 302ₖ, Endpoint B 302_{L}, and Endpoint B 302ₘ. Endpoint B can be redundantly provided on endpoints 302_{L} and 302ₘ. Redundancy can contribute to a decrease in the priority ranking of an endpoint 302 while a lack of redundancy can contribute to an increase in the priority ranking of an endpoint 302. Thus, in example network 300_{d}, Endpoint A 302ₖ can have a higher priority ranking. Redundancy can mean simultaneous operation where both redundant endpoints 302 are active. Redundancy can mean where one endpoint 302 is a backup of another endpoint 302 in case one endpoint 302 suffers a failure. Redundancy can mean how recent a backup has been made of an endpoint 302. For example, an endpoint 302 that was recently backed up can have a higher redundancy than an endpoint 302 that was backed up a long time ago.

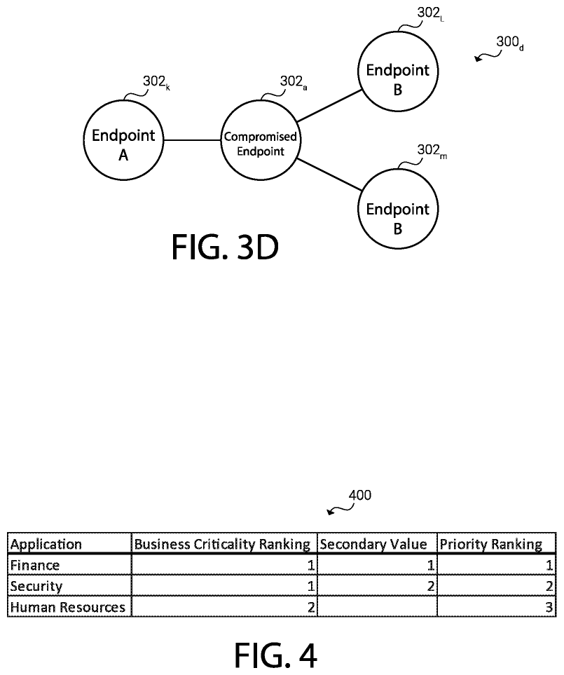

FIG. 4 shows example table 400 showing example business criticality rankings, secondary values, and priority rankings of various example applications (e.g., endpoints 302). A system (e.g., networking monitoring system 100) can use a table, database, or any other data structure similar to table 400 in order to determine priority rankings for endpoints. For example, the priority ranking can be a combination (such as a summation, weighted summation, average, maximum, etc.) of the business criticality ranking and the secondary value. The secondary value can be another factor (e.g., distance, redundancy, vulnerability, etc.) or a combination of factors. For example, a ranking or value for distance can be averaged with a ranking or value for redundancy for the application for the secondary value.

In some embodiments, a system doing triage on a network can attempt to identify and mitigate vulnerabilities. It can begin by assigning business criticality rankings to endpoints 302. In some embodiments, this might result in two endpoints 302 having the same criticality ranking. Arbitrarily deciding which endpoint 302 to triage first is possible; however applying an extra calculation to determine an ordering of the “tied” endpoints can be better. The system can then look to secondary values to tie-break. In table 400 for example, both “finance” and “security” have the same business criticality ranking, but “finance” can be considered of greater priority after considering secondary values (a value of 1 whereas “security” has a secondary value of 2).

In some embodiments, secondary values includes business criticality ranking and, instead of business criticality ranking being the primary consideration, another metric can be utilize (e.g., distance). For example, a system can determine the distance of an endpoint 302 from compromised endpoint 302ₐ and use business criticality ranking as a tie-breaking secondary value.

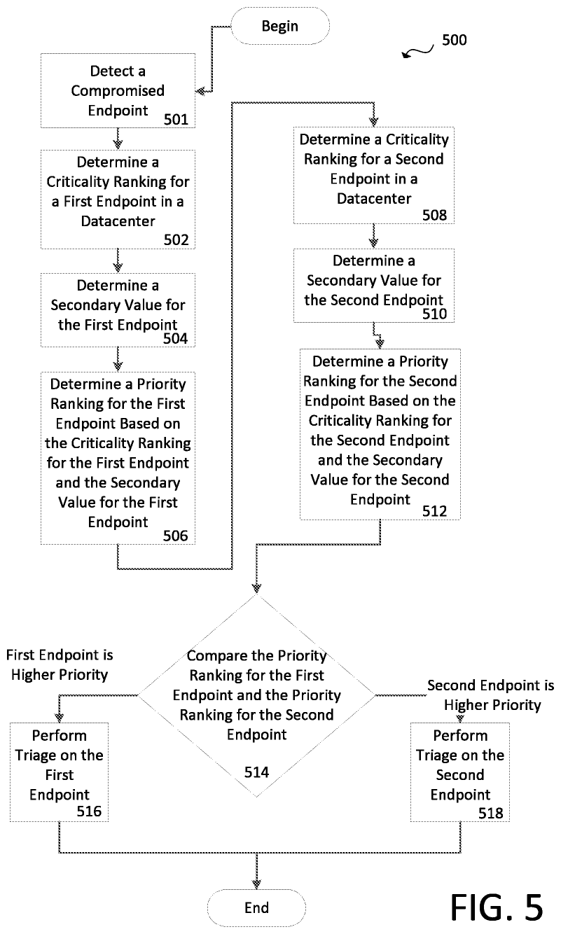

FIG. 5 shows an example method 500 according to some embodiments. A system (e.g., network monitoring system 100) performing example method 500 can begin and detect a compromised endpoint (step 501). Compromised endpoint 302ₐ can be an endpoint 302 that is running unauthorized code (e.g., a virus, trojan, worm, script, etc.), an endpoint 302 that is misconfigured, an endpoint 302 that is not authorized to be on the network, an endpoint 302 that is associated with a malicious entity (e.g., a user that has been labelled as malicious), an endpoint 302 that has been disconnected, or an endpoint 302 that otherwise is not performing optimally. Detecting compromised endpoint 302ₐ can include analyzing flow data from various sensors 104 including a sensor 104 associated with compromised endpoint 302ₐ.

After compromised endpoint 302ₐ is detected, other endpoints 302 can be triaged to determine whether they have problems or might soon have problems associated with compromised endpoint 302ₐ. For example, a virus that is installed on compromised endpoint 302ₐ might spread to connected endpoints 302. Another example is that a vulnerability on compromised endpoint 302ₐ (that caused it to be compromised) might be present on other endpoints 302. Timeliness in triage can be important because systems that rely on compromised endpoint 302ₐ might crash or have problems as a result of compromised endpoint 302ₐ not behaving regularly. Timeliness can also be important because the unwanted software installed on compromised endpoint 302ₐ might quickly spread throughout the datacenter, it can be important to determine if other endpoints 302 are compromised as well.

The system can continue and determine a criticality ranking for a first endpoint in a datacenter (step 502). Step 502 can include a network administrator labelling the first endpoint with a criticality ranking. A label can be assigned to the first endpoint (e.g., “telecommunications”) and a ranking can be derived from that label. In some embodiments, this includes referring to a prioritization list of labels. Criticality can be specific to the business of the datacenter. For example, an internet provider can have telecommunications endpoints receive a higher criticality ranking. As should be evident in this description, the term “ranking” does not necessarily require exclusivity; i.e., multiple endpoints 302 can receive identical rankings.

The system can then determine a secondary value for the first endpoint (step 504). This can include determining values (or rankings) associated with various criteria (e.g., distance, redundancy, vulnerability, etc.) and then combining multiple values (if there are multiple). Combining can include creating an average, a weighted average, a summation, etc.

The system can then determine a priority ranking for the first endpoint based on the criticality ranking for the first endpoint and the secondary value for the first endpoint (step 506). This can be generated by combining the criticality ranking and secondary value. For example, the criticality ranking can be an integer component while and the secondary value can be a decimal component of the priority ranking. The priority ranking can be a value (e.g., 9.5), a position in a queue, a relative ordering of endpoints (e.g., the first endpoint has a higher priority than a second endpoint), a group of endpoints (e.g., a first group of endpoints can be triaged first, followed by a second group), etc. In some embodiments, the priority ranking is designed to be exclusive or nearly exclusive to avoid “ties” where two endpoints would have the same priority ranking.

In some embodiments, machine learning can be utilized to inform any of the criticality ranking, the secondary value, and the priority ranking. For example, a system can monitor scenarios where compromised node 302ₐ becomes compromised and then test various priority rankings and attempt to minimize problems for other endpoints 302 by varying the priority ranking. In some embodiments, the system can run simulations of compromised endpoint 302ₐ becoming compromised and have the machine learning program learn based on the simulations.

The system can then determine a criticality ranking for a second endpoint in a datacenter (step 508). It can then determine a secondary value for the second endpoint (step 510). It can then determine a priority ranking for the second endpoint based on the criticality ranking for the second endpoint and the secondary value for the second endpoint (step 512). Steps 508, 510, and 512 can be similar to steps 502, 504, and 506, respectively but for the second endpoint 302.

The system can then compare the priority ranking for the first endpoint and the priority ranking for the second endpoint (step 514). In some embodiments, the endpoint 302 with the higher priority ranking is triaged first.

In some embodiments, the system performing example method 500 can determine a criticality ranking for the first endpoint (step 502) and the second endpoint (step 508). After determining the respective criticality rankings, the system can determine that they are identical. In order to “break the tie”, the system can then analyze the respective secondary values (steps 504 and 508). For example, it can determine the respective distances, and perform triage on the endpoint 302 that is fewer hops away from compromised node 302ₐ. Depending on how the secondary values are calculated, it is contemplated that there can be a tie even after comparing secondary values. The system can then determine tertiary values of the respective endpoints. Tertiary values can be calculated using some of the criteria not analyzed when calculating secondary values.

If the first endpoint has a higher priority, the system can perform triage on the first endpoint (step 516). If the second endpoint has a higher priority, the system can perform triage on the second endpoint (step 518). The endpoint 302 that is not triaged at first (in steps 516 or 518) can be triaged later. For example, the system can perform triage on the second endpoint in step 518 and then perform triage on the first endpoint.

Triage can mean creating a backup of the endpoint 302, adding redundancy to the endpoint 302 (e.g., duplicating the endpoint 302), scanning the endpoint 302 for viruses, having an administrator review the endpoint 302, applying stricter security settings for the endpoint 302, limiting the traffic to the endpoint 302, retrieving data from endpoint 302, retrieving data from a sensor 104 associated with the endpoint 302, analyzing data from a sensor 104 associated with the endpoint 302, analyzing the endpoint 302 for vulnerabilities (especially the vulnerabilities that compromised node 302ₐ), changing an associated endpoint group for the endpoint 302, shutting down the endpoint 302, moving the endpoint 302 (e.g., if the endpoint 302 is a virtual machine or container, migrating it to another machine), etc.

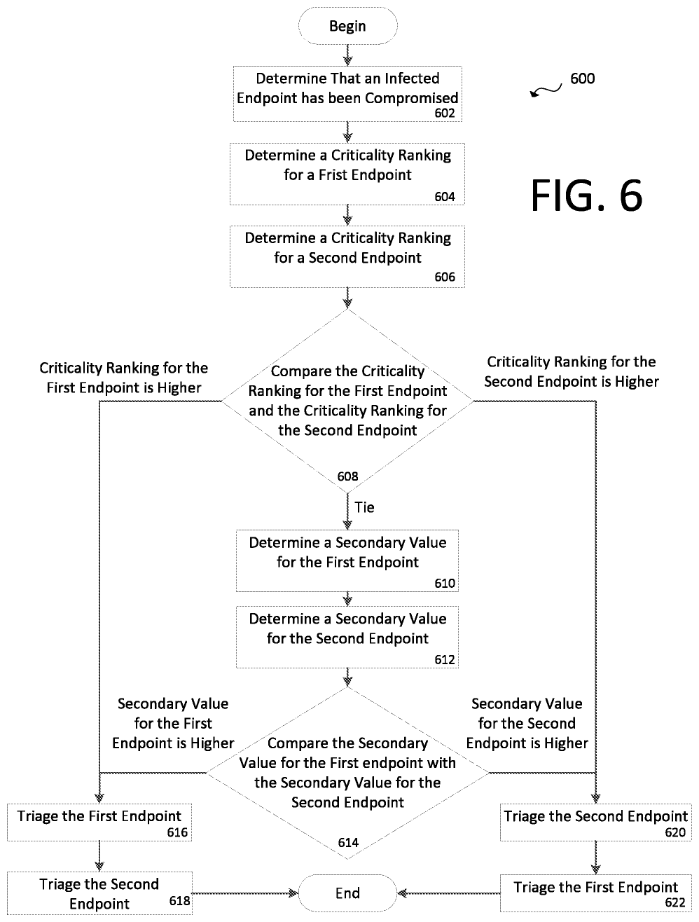

FIG. 6 represents an example method 600 according to some embodiments. The example method can be performed by a system such as traffic monitoring system 100. The system can begin and determine that an infected endpoint has been compromised (step 602). For example, it can determine that an endpoint is misconfigured, hacked, insecure, running malicious code, etc. The system can then determine a criticality ranking for a first endpoint (step 604). It can then determine a criticality ranking for a second endpoint (step 606). The criticality rankings can be according to business criticality, that is, how much the business that runs the endpoints is dependent on these endpoints.

The system can then compare the criticality ranking for the first endpoint and the criticality ranking for the second endpoint (step 608). If there is a tie, meaning that the criticality rankings are the same or substantially the same. The system can determine a secondary value for the first endpoint (step 610). The system can then determine a secondary value for the second endpoint (step 612). The secondary value can be any combination of: an endpoint's distance to the compromised endpoint, the endpoint's similarity to the compromised endpoint (including vulnerability similarities), the endpoint's redundancy, etc.

The system can then compare the secondary value for the first endpoint with the secondary value for the second endpoint (step 614). In some embodiments, the secondary values are calculated in order to prevent a tie. If there is a tie, tertiary values (based on possible secondary criteria that were not used to determine the secondary criteria) can be determined.

If the criticality ranking for the first endpoint is higher (at step 608) or if the secondary value for the first endpoint is higher (at step 614), the system can triage the first endpoint (step 616). The system can then triage the second endpoint (step 618).

If the criticality ranking for the second endpoint is higher (at step 608) or if the secondary value for the second endpoint is higher (at step 614), the system can triage the second endpoint (step 620). The system can then triage the first endpoint (step 622).

Any of the steps in example method 600 can be accomplished with the assistance of sensors installed within the related datacenter, including the infected endpoint, the first endpoint, and the second endpoint.

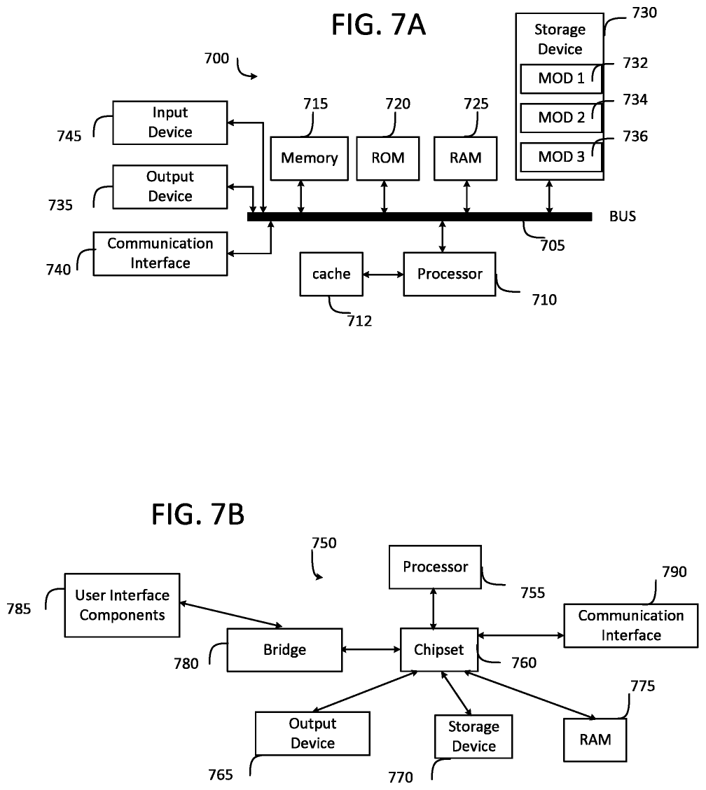

FIG. 7A and FIG. 7B illustrate example system embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Example system 700 includes a processing unit (CPU or processor) 710 and a system bus 705 that couples various system components including the system memory 715, such as read only memory (ROM) 770 and random access memory (RAM) 775, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 737, module 7 734, and module 3 736 stored in storage device 730, configured to control the processor 910 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 775, read only memory (ROM) 770, and hybrids thereof.

The storage device 730 can include software modules 737, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates an example computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that example systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

1. A computer-implemented method comprising:
determining a first ranking of a first endpoint, wherein the first ranking is determined by metadata defining a criticality of the first endpoint to a network;
determining a second ranking of a second endpoint, wherein the second ranking is determined by metadata defining a criticality of the second endpoint to the network;
comparing the first ranking and the second ranking; and
in response to the comparing, performing an operation on one of the first endpoint or the second endpoint.

2. The computer-implemented method of claim 1, further comprising:
in response to the first ranking being greater than the second ranking, the operation including triaging the first endpoint.

3. The computer-implemented method of claim 1, further comprising:
in response to the second ranking being greater than the first ranking, the operation including triaging the second endpoint.

4. The computer-implemented method of claim 1, further comprising:
in response to the first ranking and the second ranking being substantially equal, the operation including a tie-breaker process including:
determining, based on a first value of the first endpoint and a second value of the second endpoint, that one of the first endpoint and the second endpoint is a higher priority endpoint; and
triaging the higher priority endpoint.

5. The computer-implemented method of claim 1, wherein determining the first ranking and the second ranking are performed via machine learning.

6. The computer-implemented method of claim 1, further comprising:
detecting a compromised endpoint.

7. The computer-implemented method of claim 6, wherein the detecting of the compromised endpoint includes analyzing flow data from a plurality of sensors associated with the compromised endpoint.

8. The computer-implemented method of claim 6, wherein the comprised endpoint is either misconfigured, hacked, insecure or running malicious or unauthorized code.

9. A system comprising:
at least one processor; and
at least one memory including instructions that when executed by the at least one processor, cause the system to:
determine a first ranking of a first endpoint, wherein the first ranking is determined by metadata defining a criticality of the first endpoint to a network;
determine a second ranking of a second endpoint, wherein the second ranking is determined by metadata defining a criticality of the second endpoint to the network;
compare the first ranking and the second ranking; and
in response to the comparing, perform an operation on one of the first endpoint or the second endpoint.

10. The system of claim 9, further comprising:
in response to the first ranking being greater than the second ranking, the operation including triaging the first endpoint.

11. The system of claim 9, further comprising:
in response to the second ranking being greater than the first ranking, the operation including triaging the second endpoint.

12. The system of claim 9, further comprising:
in response to the first ranking and the second ranking being substantially equal, the operation including a tie-breaker process including additional instructions that when executed by the at least one processor, cause the system to:
determine, based on a first value of the first endpoint and a second value of the second endpoint, that one of the first endpoint and the second endpoint is a higher priority endpoint; and
triage the higher priority endpoint.

13. The system of claim 9, wherein determining the first ranking and second ranking are performed via machine learning.

14. The system of claim 9, further comprising instructions that when executed by the at least one processor, cause the system to:
detect a compromised endpoint.

15. The system of claim 14, wherein the detecting of the compromised endpoint includes analyzing flow data from a plurality of sensors associated with the compromised endpoint.

16. The system of claim 14, wherein the comprised endpoint is either misconfigured, hacked, insecure or running malicious or unauthorized code.

17. At least one non-transitory computer-readable medium having computer readable instructions that, when executed by at least one processor, cause the at least one processor to:
determine a first ranking of a first endpoint, wherein the first ranking is determined by metadata defining a criticality of the first endpoint to a network;
determine a second ranking of a second endpoint, wherein the second ranking is determined by metadata defining a criticality of the second endpoint to the network;
compare the first ranking and the second ranking; and
in response to the comparing, perform an operation on one of the first endpoint or the second endpoint.

18. The at least one non-transitory computer-readable medium of claim 17, further comprising:
in response to the first ranking being greater than the second ranking, the operation including triaging the first endpoint.

19. The at least one non-transitory computer-readable medium of claim 17, further comprising:
in response to the second ranking being greater than the first ranking, the operation including triaging the second endpoint.

20. The at least one non-transitory computer-readable medium of claim 17, further comprising:
in response to the first ranking and the second ranking being substantially equal, the operation including a tie-breaker process including additional instructions that when executed by the at least one processor, cause the at least one processor to:
determine, based on a first value of the first endpoint and a second value of the second endpoint, that one of the first endpoint and the second endpoint is a higher priority endpoint; and
triage the higher priority endpoint.
